(19) United States
(12) Patent Application Publication
(10) Pub. No.: US 2007/0300017 A1
(43) Pub. Date: Dec. 27, 2007

(54) Organizing Content

(75) Inventors: Freddy Snijder, Weert (NL); Wilhelmus Henrica Van Den Boomen, Eindhoven (NL); Alexander Borisovich Kobzhev, Eindhoven (NL); Esko Olavi Dijk, 'S-Hertogenbosch (NL); Johan Sebastiaan Van Gageldonk, Eindhoven (NL); Declan Patrick Kelly, Eindhoven (NL); Godert Willem Leibbrandt, Eindhoven (NL); Gerhardus Engbertus Mekenkamp, Valkenswaard (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Phillips Electronics, N.V., Eindhoven (NL)

(21) Appl. No.: 11/575,684

(22) PCT Filed: Sep. 16, 2005
(86) PCT No.: PCT/IB05/53052

§ 371 Date: Mar. 21, 2007

(30) Foreign Application Priority Data
Sep. 21, 2004 (EP) 04104564.2

(51) Int. Cl. G06F 12/00; G06F 17/30

(52) U.S. Cl. 711/148; 707/3; 711/E12.078; 707/E17.014

(57) ABSTRACT

A portable data storage device (1) comprising means (2, 4) for searching for data stored on an other device that match with a user set profile (3) of the data storage device (1) and means (5) for storing data matching with said profile (3) in the data storage device (1). Also a technical realization on the level of self organizing content entities is provided.

The invention relates to a portable data storage device

The invention further relates to a system for the storage of data.

The invention further relates to a method of a self organizing storage of data.

The invention further relates to a method of organizing of content in a network.

The invention further relates to a computer program product.

Portable data storage devices are well known from the state of the art. Such storage devices, e.g. CDs, DVDs, floppy discs or USB sticks, have the disadvantage that they are just “passive” storage media. This means that these devices have no intelligence of their own and therefore cannot exert influence for instance on the kind of content or data stored (e.g. mp3 music, video, jpeg pictures, documents etc). Therefore every time a user wants to store content on such a device the user must manually select the respective content. Thus the ease of use is rather low.

It is an object of the invention to provide a device of the type defined in the opening paragraph, a system of the type defined in the second paragraph, a method of the type defined in the third paragraph, a method of the type defined in the fourth paragraph and a computer program product of the type defined in the fifth paragraph, in which the disadvantages defined above are avoided.

In order to achieve the object defined above, with a device according to the invention characteristic features are provided so that a device according to the invention can be characterized in the way defined below, that is:

A portable data storage device comprising means for searching for data stored on another device that match with a user configurable profile of the data storage device and for receiving data from another device and means for storing said received data in the data storage device if they match with said profile.

In order to achieve the object defined above, with a system according to the invention characteristic features are provided so that a system according to the invention can be characterized in the way defined below, that is:

A distributed self organizing system for the storage of data, which system comprises at least two autonomous storage devices comprising means for exchanging data with one another, wherein the system is arranged to search for data stored on the storage devices, that match with a user set storage profile of at least one of the data storage devices and to store data matching with said storage profile of a data storage device in that device.

In order to achieve the object defined above, with a method according to the invention characteristic features are provided so that a method of a self organizing storage of data according to the invention can be characterized in the way defined below, that is:

A method of a self organizing storage of data, wherein it is searched for data stored on a first data storage device that match with a user set storage profile of a second data storage device, wherein data stored on the first data storage device matching with the profile of the second data storage device will be stored in the second data storage device.

In order to achieve the object defined above, with a further method according to the invention characteristic features are provided so that a method of self organizing of content in a network according to the invention can be characterized in the way defined below, that is:

A method of organizing of content in a network of devices, content being stored on a device and comprises representation-data for representing the content and organizing-data for organizing the content in the network, the method comprises the following steps:

on a first device, on which the first content is stored, using said first content for creating an organizing-request by the aid of the organizing-data of said first content; and

communicating the organizing-request from said content to another content stored in the first device or stored in at least a second device in the network; and re-arranging the distribution of content dependent on the response to the organizing-request.

In order to achieve the object defined above, with a computer program product to the invention characteristic features are provided so that a computer program product according to the invention can be characterized in the way defined below, that is:

A computer program product directly loadable into the memory of a programmable device, comprising software code portions for performing the steps of a method of a self organizing storage of data according to the invention or for performing the steps of a method of organizing of content in a network according to the invention.

The measures according to the invention provide the advantage that it is possible to achieve a physical and semantically self-organization of memory contents. Since the data are stored on different devices according to the user set storage profiles of the devices, a user is enabled to physically retrieve stored content by selecting a storage device. Also self-organization of content based on the intelligence of the content itself is advantageously enabled, which only requires a user to trigger the process of self-organization.

The measures as claimed in claim 2 or in claim 23, provide the advantage that a physical organization of contents stored can be achieved very quickly and efficiently.

However, it has proved to be particularly advantageous if the measures of claim 3 are provided. This achieves the advantage of an optimal allocation of contents to storage devices based on semantics.

The measures as claimed in claim 4 or in claim 24 provide the advantage that a storage device autonomously decides whether data match with a content defined in its user set profile or not. So the storage device does not need any additional information about the data stored. Thus a certain intelligence of the storage device is provided.

The measures as claimed in claim 5 or in claim 13 or in claim 26, provide the advantage that the decision whether data match with the user set storage profile or not is: done very quickly and with just a little complexity.

The measures as claimed in claim 6 provide the advantage that a self organizing system of storage devices is achieved very easily achieved just by putting two or more storage devices close together or connecting them into one network.

The measures as claimed in claim 7 provide the advantage that a user is able to see the content stored on a storage device, e.g. by means of a display showing the content stored.

The measures as claimed in claim 8 provide the advantage that a user can easily recognize at a glance which kind of content is stored on a certain storage device by its appearance.

The measures as claimed in claim 9 or in claim 18 allows a user, after selecting a storage device according to rudimental information provided by illumination means, to view the content stored on this device in more detail and to easily retrieve content stored.

The measures as claimed in claim 10 provides a very efficient power management of the storage device.

The measures as claimed in claims 11 or in claim 20 or in claim 28 allow to define the behavior of the storage device in a storage system or to realize an archival system when considering the creation or change date of data when performing the storage.

The measures as claimed in claim 13 further provides the advantage that the system autonomously analyzes the content of data without the need of receiving additional information from outside. Further it can be proved very easily using the meta data, whether content stored on a device matches with the profile of another device.

The measures as claimed in claim 15 or in claim 19 or in claim 25 provide the advantage that the storage devices can be realized very simply and with low costs.

The measures as claimed in claim 16 provide the advantage that a self organizing storage system can be realized very simply and with low effort.

The measures as claimed in claim 17 or in claim 27 provide the advantage that a content analysis can be done very quickly and very efficient without the need for a high computing power in a single storage device.

The measures as claimed in 21 provide the advantage that a distributed meta database can be achieved very easily.

The measures as claimed in claim 29 provide the advantage that an update of the storage device can be achieved very simple.

The measures as claimed in claim 30 provide the advantage that the expertise of the storage device can be changed according to the users needs.

The measures as claimed in claim 31 provide the advantage that new content not already available in the storage system or on the storage device can automatically be downloaded without the assistance of the user.

The measures as claimed in claim 33 provide the advantage that intelligent content in the form of autonomous content entities perform the act of re-organizing the distribution of content within the network on its own initiative and under its own control by the aid of the executable command or commands.

The measures as claimed in claim 34 provide the advantage that active content entities can exchange representation-data between each other or provide copies of representation-data to be used by other autonomous content entities.

The measures as claimed in claim 35 provide the advantage that autonomous content entities can be re-allocated between devices on its own initiative.

The aspects defined above and further aspects of the invention are apparent from the examples of embodiment to be described hereinafter and are explained with reference to these examples of embodiment.

The invention will be described in more detail hereinafter with reference to examples of embodiment but to which the invention is not limited.

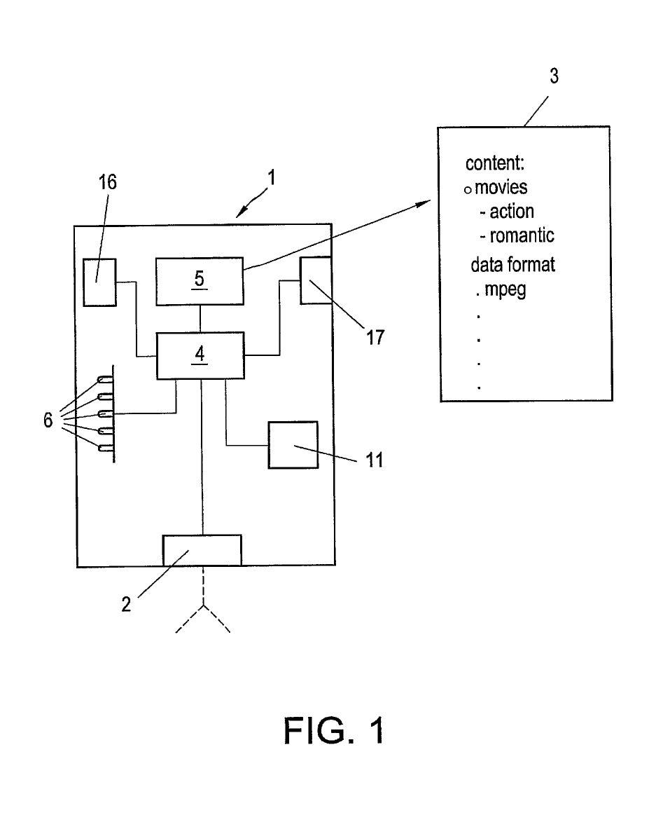

FIG. 1 shows a portable storage device according to the invention in the form of a block circuit diagram.

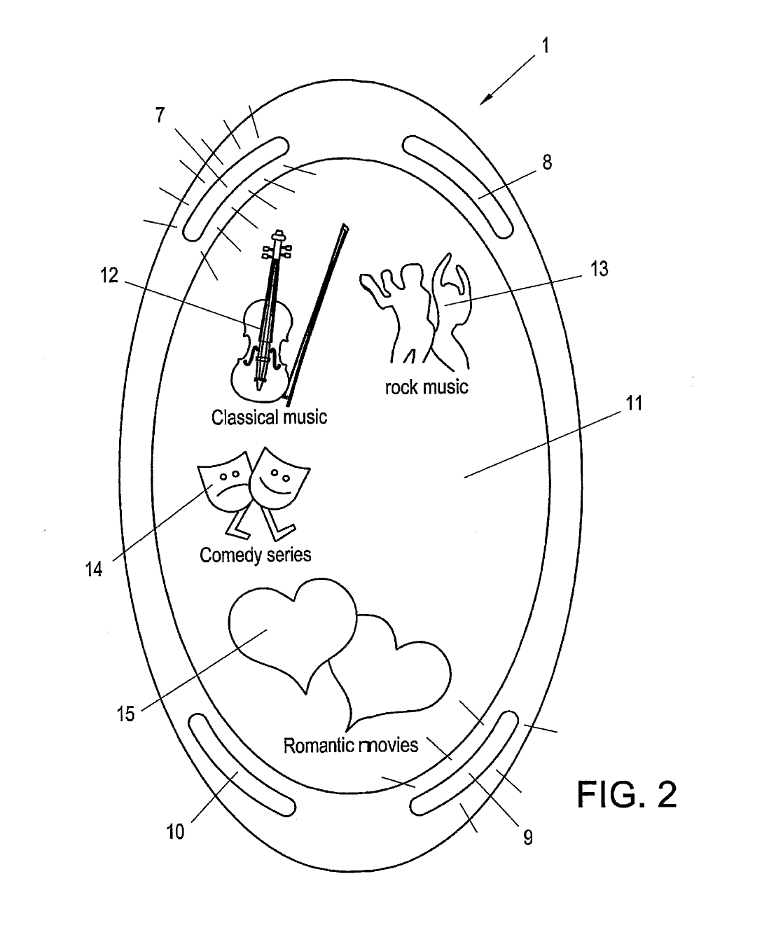

FIG. 2 shows a schematic plan view of a portable storage device according to the invention.

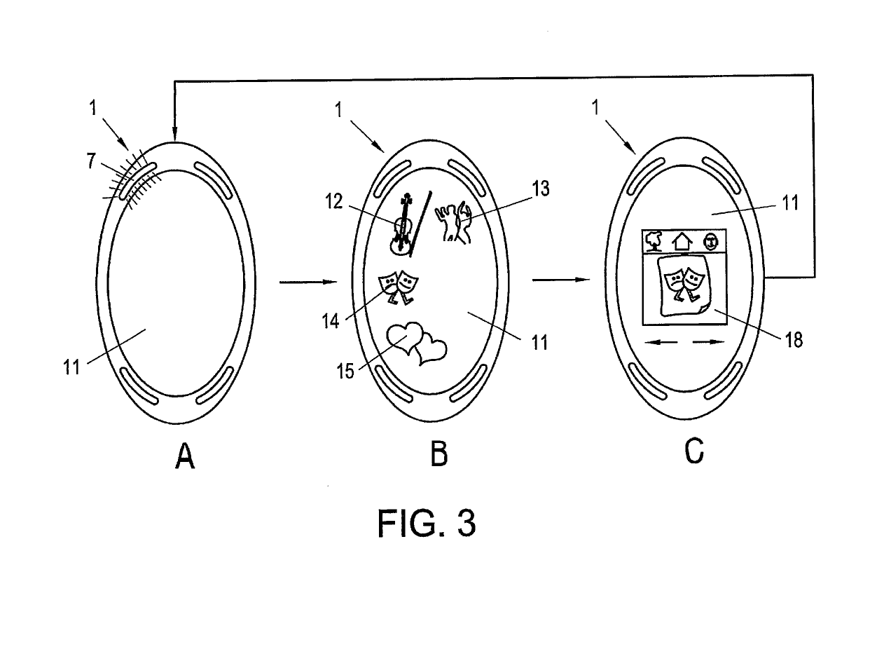

FIG. 3 shows a flow chart of a content retrieval procedure.

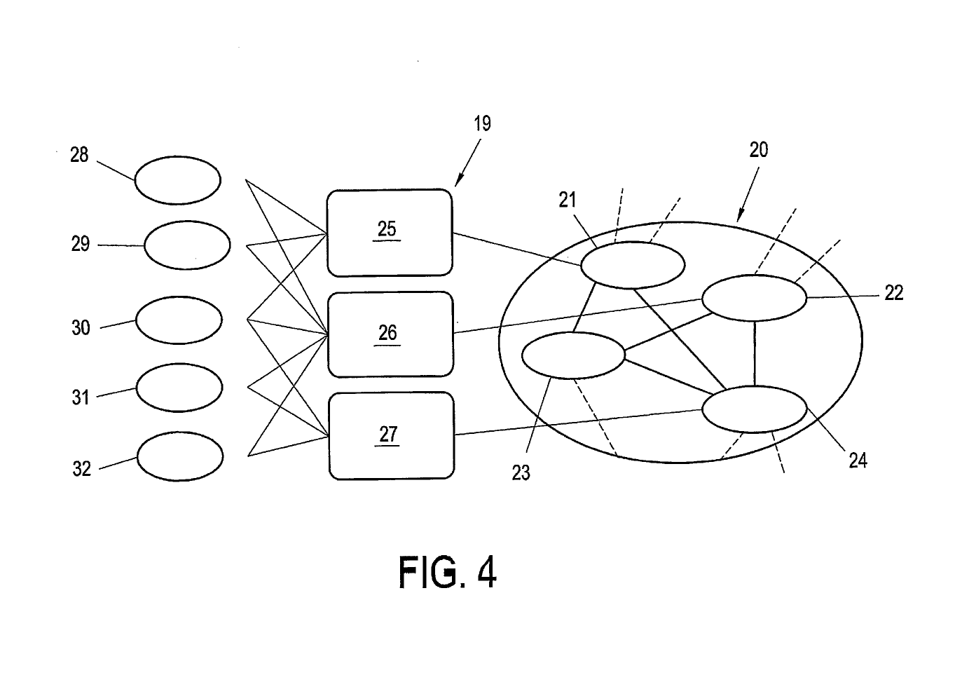

FIG. 4 shows a self organizing storage system according to the invention.

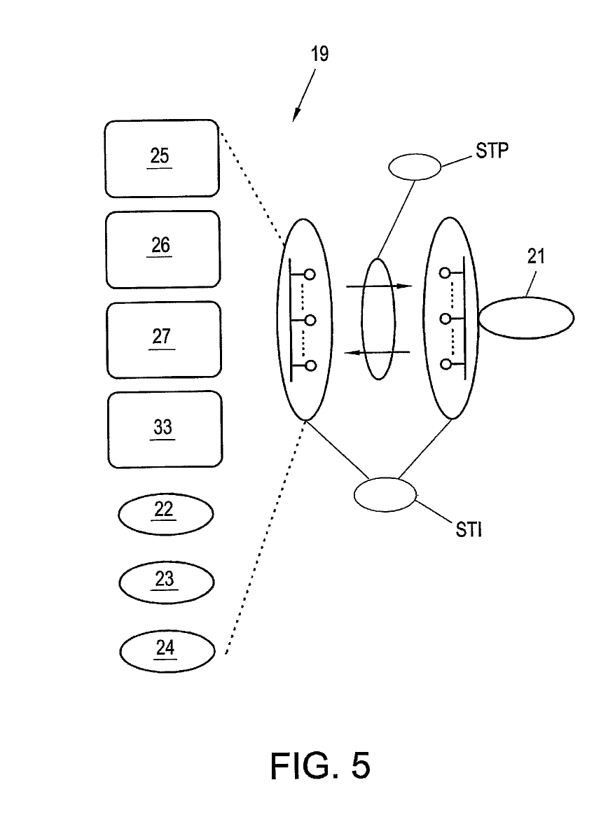

FIG. 5 shows interfacing between system parts in the storage system of FIG. 4.

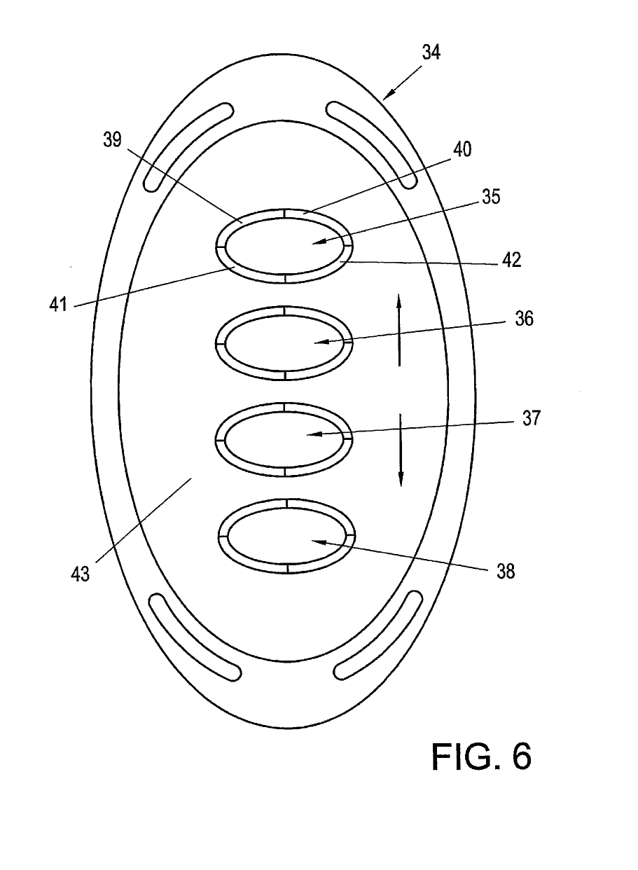

FIG. 6 shows a storage manager device.

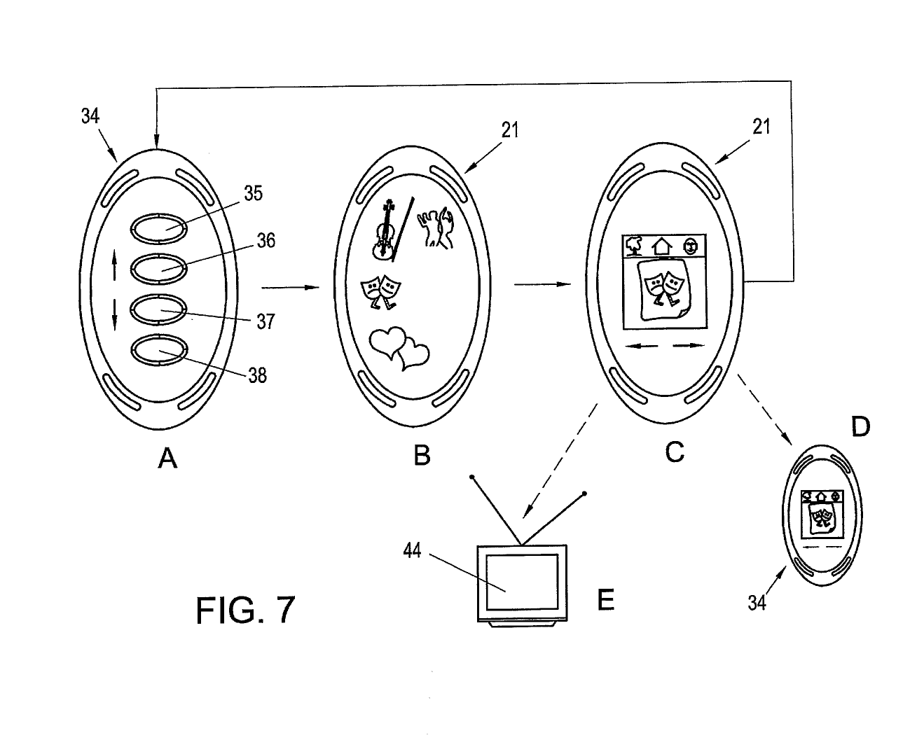

FIG. 7 shows a flow chart of a storage retrieval process in the storage system as it is shown in FIGS. 4 and 5.

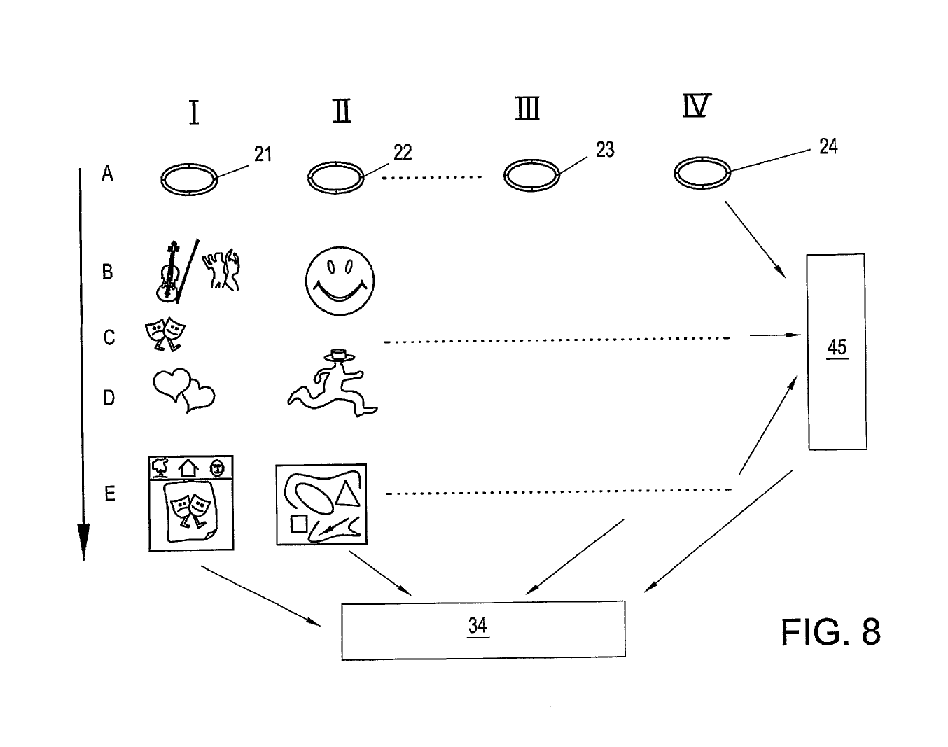

FIG. 8 shows a method of representing the content stored in the storage system of FIG. 4.

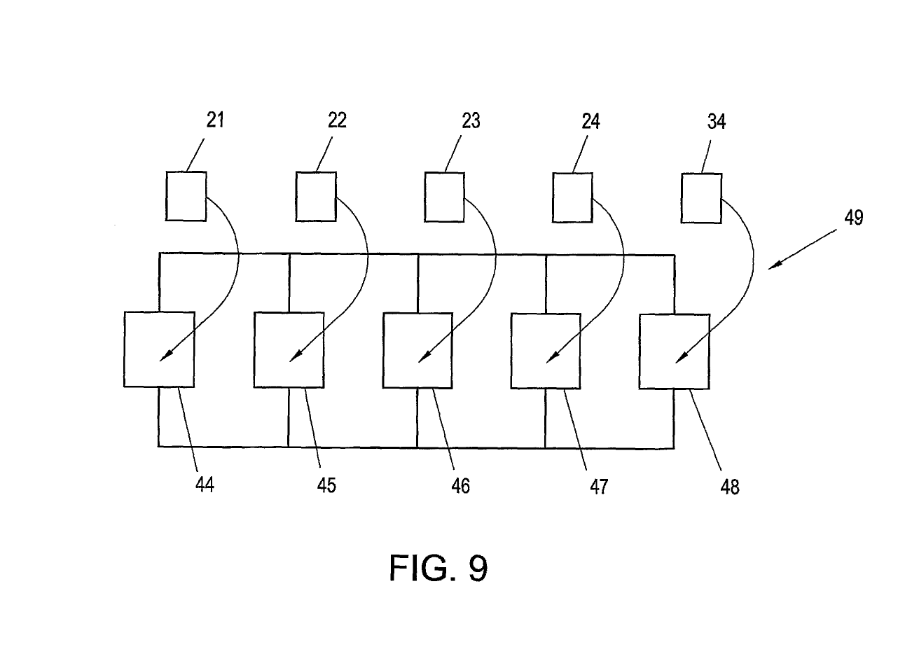

FIG. 9 shows a grid tray for storage devices.

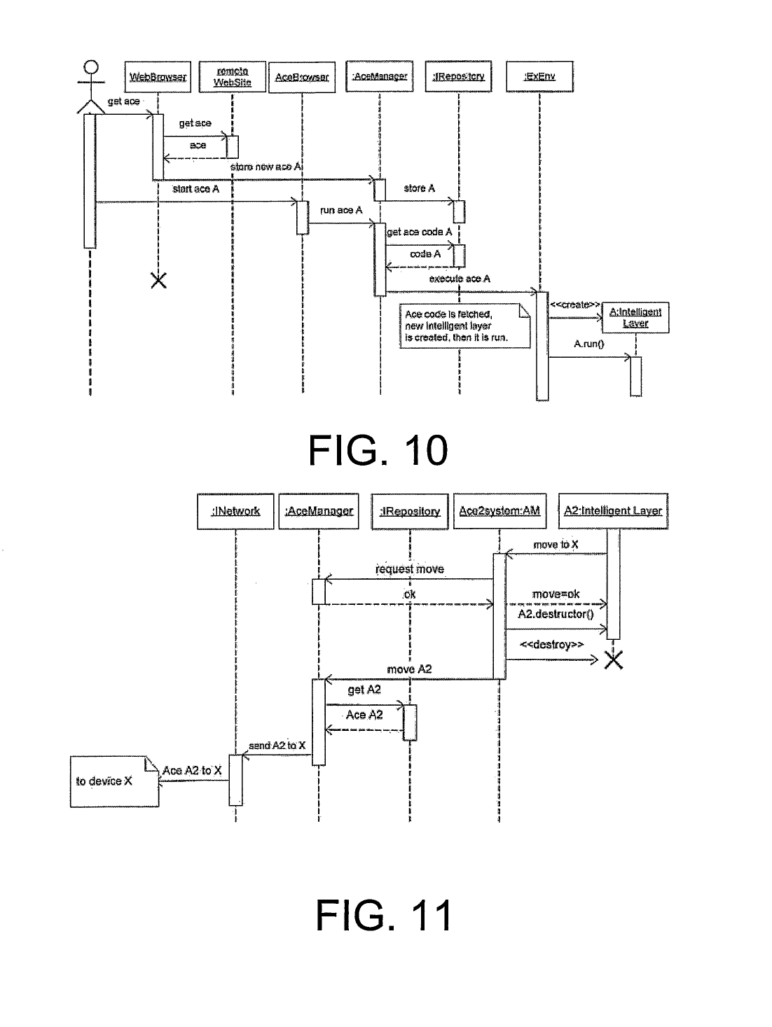

FIG. 10 shows in a sequence diagram how a user receives and autonomous content entity and executes its intelligent layer.

FIG. 11 shows in a sequence diagram how an autonomous content entity requests to be moved to another device.

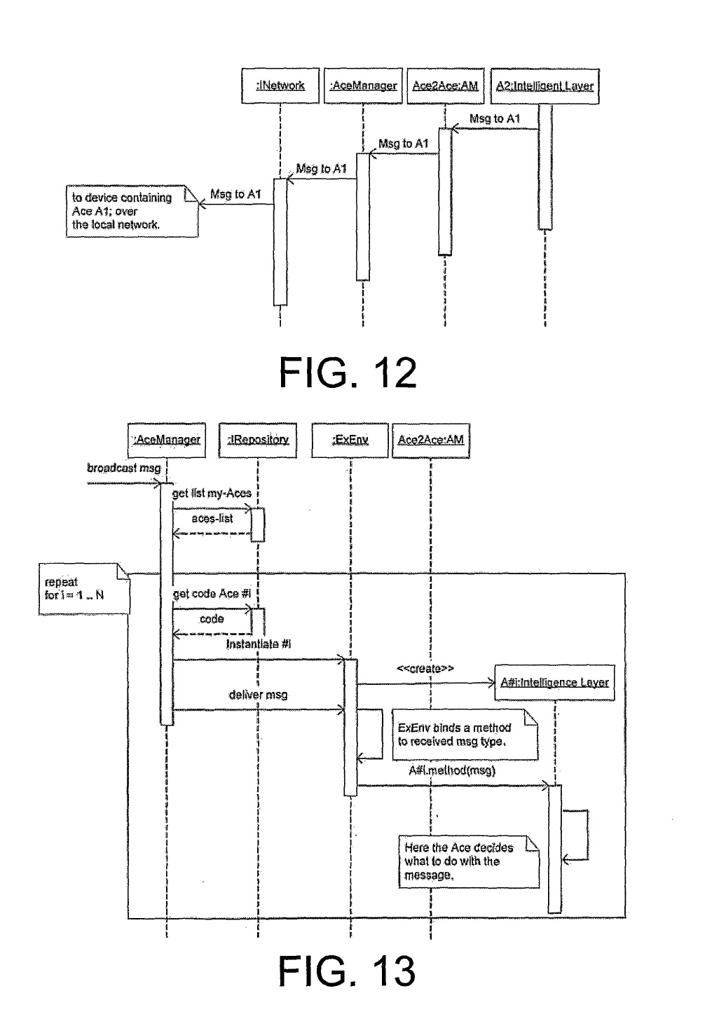

FIG. 12 shows in a sequence diagram how an autonomous content entity sends a massage to another autonomous content entity.

FIG. 13 shows in a sequence diagram how an autonomous content enabled device receives a broadcast message, which is dispatched to all autonomous content entities locally stored on the device.

The Figures are schematically drawn and not true to scale, and the identical reference numerals in different Figures refer to corresponding elements. It will be clear for those skilled in the art, that alternative but equivalent embodiments of the invention are possible without deviating from the true inventive concept, and that the scope of the invention will be limited by the claims only.

FIG. 1 shows a portable storage device according to the invention. The portable storage device according to the invention, in the following for the reason of easier readability indicated as “storage bubble 1”, is an autonomous storage container. “Autonomous” means that the storage bubble 1 forms an independent structural unity. The storage bubble 1 comprises means for autonomously looking for data stored on another device matching with a user set storage profile 3 of the storage bubble 1. At this point it is important to mention that autonomous means that it can act by itself.

This means for autonomously looking for data and storing these data are, according to the embodiment shown, by means of a processor 4, which comprises a respective software that is executable by the processor 4, communication means 2 connected with the processor 4 and at least one permanent memory 5 connected with the processor 4. Instead of using the suitable programmed processor 4 the storage bubble 1 can be provided with one or more circuits realizing the same functionalities. It is to mention that also a dynamic memory can be provided in the meaning of having a memory and a processor integrated into each other. The communication means 2 can be realized e.g. with means for wireless communication as they are state of the art for instance means for Bluetooth or Wireless Fidelity Connection (WI-FI) or communication according to the NFC standard. By means of the communication means 2 the storage bubble 1 can communicate with other storage bubbles or other devices. Furthermore the storage bubble 1 comprises an internal current supply that is not shown in FIG. 1, e.g. an battery or an accumulator. The storage bubble 1 has preferably no means for rendering content. Thus an optical or acoustic rendering of content, preferably except meta data, takes place on a remote rendering device. However, in principle the storage bubble can be merged with a rendering device too.

A user can set a profile 3 for the storage bubble 1 being for instance: “This bubble will be used in low bandwidth environments (e.g. environments where only communication via Bluetooth is available) or popular music only.”

This profile 3 provides the storage bubble 1 with information about the content to gather. The profile 3 is, according to the embodiment shown, stored in the permanent memory 5 of the storage bubble 1 and be defined at different levels of granularity.

The profile 3 can for instance only contain information about the type of content that shall be stored in the permanent memory 5 of the storage bubble 1, e.g. audio, video, digital pictures and text or other types of data. In this case the storage bubble 1 will collect any audio, video, text or other type of data. For all content types selected in the profile 3 a bandwidth profile can be given by providing a target bit rate or target communication technology, e.g. Bluetooth for the selected content type.

Further the user can give more specific information about the chosen content when setting up the profile 3. Setting up the profile 3 for videos can be based on a selection from a standard set of genres, events or content moods (romantic, funny, etc.). Setting up the profile 3 for videos can be further based on keywords in the title, author information and spoken words in the content or pieces of video for example.

For audio data the set up of the profile 3 can be based on a selection from a standard set of genres, events or content moods. Setting up the profile 3 for audio contents can also be based on keywords in the title, artist information and spoken/sung words in the content. Audio profiles can in principle also be based on “humming” or other acoustic information, i.e. the user hums what the audio should sound like. In the last case the storage device can comprise means for the input of voice such as a microphone.

For text contents setting up the profile 3 can be based on keywords.

For data of any type setting up the profile 3 can be based on file name and file extension.

However it is possible that the profile 3 contains information of how to deal with contents created on certain dates. Thus it is possible to discriminate on file creation or—change date. In this way storage bubbles 1 interconnected with one another and constituting a network as shown in FIG. 4 and described in the following can organize the available content according to the profile 3 based on time, what results in an automatic archival system. Of course profiling based on content and creation date can be combined. In this way a storage profile 3 can be created such that the storage bubble 1 will store for example the latest news.

The storage bubble 1 also comprises an input device, not shown in FIG. 1, for the input of the storage profile 3, e.g. a touch screen, with a menu navigation. Furthermore the storage profile 3 can for instance be entered via an external computer connected with the storage bubble 1 via a wireless or wired connection. In this case a user interface of the storage bubble 1 for entering the profile 3 can be transferred to the computer and shown on a display of the computer.

To make setting of the profile 3 easier a user can, according to an embodiment of the invention, choose from preset contents and data formats the favored contents and formats, e.g. by activating the desired contents and formats via mouse click. However, it can also be provided that several pre-defined profiles are available. Thus a user can choose one of several preset profiles of the bubble 1.

In addition the profile 3 could be set by giving one or more content items. For example the user may select several photos, e.g. beach photos, and then tell the storage bubble 1 to generate a profile 3 based on these photos. After this the storage bubble 1 will look for other beach photos stored on other devices as well. This provides the advantage that the user does not have to specify a detailed profile 3, he only has to provide examples of the content that he wants to be stored on the storage bubble 1.

In a further embodiment the profile is sent wireless to the bubble 1. To this end, the bubble has an RF-ID reader for reading tags that hold a profile 3 stored as data in them. A user can set or change a profile 3 of bubble 1 by holding a tag close to the bubble and confirming a “set profile” action in a suitable way, e.g. pressing confirm on a touch sensitive screen. Another suitable wireless transmission mechanism may be used for sending the profile 3, e.g. via an optical barcode.

An important concept used within the organization of data in the present context are content meta data. These meta data provide information about content such as: Title of content, video/program or music genre, positions of events in the content, such as football goal events, content mood, low-level content features (average luminance, amount of motion in video content, audio features, etc.), content signatures (humming signature for instance), information of how content is encoded, bit rate information, objects on a photo, etc.

The meta data of content are used to decide, based on the storage profile 3, if the content stored on an other device is of interest to the storage bubble 1 and if and how the content shall be processed. Meta data of content could be already available from a stationary storage device however this should not be expected by default. In order to keep the storage bubble 1 independent from the functionality of other devices the storage bubble 1 can comprise means for analyzing data on its own. This analyzing means can for instance be realized with a software installed on the processor 4 of the storage bubble 1. This analyzing software can be realized by means of a software as, for instance, commonly used for speech pattern recognition. The analyzed data can for instance be searched for specific keywords. According to the result of the analyzing process meta data containing information about the analyzed content can be created. This meta data can provide the information described above. The meta data of analyzed content are preferably stored in the storage bubble 1.

Whether a content, or to be more exact the data containing this content, match with the profile 3 of the storage bubble 1 can be proved via comparing the profile 3 with the meta data of the possible content.

According to an embodiment of the invention the storage profile 3 of the storage bubble 1 can also contain information about the desired storage bubble behavior concerning for instance when to delete or move what content and what part of the content profile 3 has higher priority than another part of the content profile 3. When almost all the storage capacity of the storage bubble 1 is used the storage bubble 1 can make a decision how to respond to this situation. Thus the storage bubble 1 can request an other storage bubble of a network 20 of storage bubbles 1 as shown in FIG. 4 to accept content that fits the content profile 3 less than other content stored on the asking storage bubble 1. So some content defined by the profile 3 can be given more priority than other content. This priority can be defined by the user in the storage profile 3 when setting up this profile 3 of the bubble 1.

Further it can be defined in the profile 3 what to do when the storage bubble 1 is full and no other storage bubble accepts content. In this case the bubble 1 can according to the settings of the user profile 3 delete content directly, stop immediately with gathering content or delete content only after a few days or weeks and then continue gathering and organizing. All these features of the storage bubble 1 are provided by the aid of the communication means 2, the memory 5 and the processor 4 mentioned above.

In addition the processor 4 of a first storage bubble 21 can e.g. comprise a software for watching how full the memory 5 is. If the stored content in memory 5 represents a size that is more than a certain threshold the processor 4 can transmit via the communication means 2 content and the allocated meta data to another storage bubble 22.

If a first storage bubble 21 requests the transfer of content to a second storage bubble 22 because the first storage bubble 21 is full there is provided an acceptance policy in place. This policy can for instance be based on the level of profile fitness of the content, the storage capacity available and a minimum reserve storage capacity of the second storage bubble 22.

The content from stationary storage devices or other storage bubbles copied or moved to the storage bubble 1 can be downscaled versions or otherwise processed versions of the original content. For instance to watch a video on a Personal Digital Assistant while traveling could require a low bit rate or low resolution version of the original video. Said downscaling and processing can be carried out for instance by means of a suitable programming of the processor 4.

In principle content processing functions, such as transcoding, that are frequently needed are realized in the storage bubble 1 itself, as mentioned above, to keep it as autonomous as possible.

But according to another embodiment of the invention it is also possible that a stationary storage device or any other device processes the content of interest for the interested storage bubble 1 as a service. For instance a Hard Disc Drive recorder usually has an encoder/decoder functionality. This functionality can be used to transcode a requested video stream to the requested format. Transcoding and other processing functionalities are, according to a preferred embodiment of the invention, offered through standardized interfaces and service discovery, for instance using Universal Plug and Play (uPnP).

The storage bubble 1 further comprises, according to the embodiment of the invention as shown in FIG. 1, means for content indication. This means can for instance be realized with LEDs 6 which light up a housing of the storage bubble I in different colors according to the content stored.

According to FIG. 2 the exterior of the storage bubble 1 is divided into a number of sections 7, 8, 9, 10 (for instance four) representing different types of content, e.g. audio, video, digital pictures and text (Word, pdf, etc.) or data (Excel, binary data not audio or video etc.) or indicating semantics like, for instance, “beach” photos, family pictures, “scuba-diving” pictures and pictures of a new born child. Every section 7, 8, 9, 10 has its own color created by using LEDs, as mentioned above, or other means of illumination. How many data of a certain kind or content are stored in the storage bubble can be shown by the intensity of the assigned color. For instance the brighter the color allocated to a certain content is the more of that kind of content is stored on the bubble I. In other words the external appearance of the storage bubble 1 can depend on the content stored in the bubble 1. For instance if the storage bubble 1 changes into red it indicates that it mostly contains audio or if the device turns into green it indicates that mainly action movies are stored on it. In this way a rudimentary selection of content from a set of portable storage devices is made very easy for the user.

When a bubble 1 is selected based on this rudimentary information about the content, more detailed indication methods can provide further information about the content to the user, e.g. by means of a display 11 on which the user can browse through the content stored on the storage bubble 1.

For instance the display 11 of the storage bubble 1 can show multiple icons 12, 13, 14, 15 of different sizes, wherein an icon indicates what content is stored and the size of the icon 12, 13, 14, 15 indicates how much is stored of that content type.

According to another embodiment of the invention E-ink displays can be used. This means that the icons 12, 13, 14, 15 on the display 11 remain visible for a few days even though the display is not powered. In such a way there may be no need for LIED lights for indication. The display could actually be a “skin” of the device; the skin is visible from all sides making it more easy to visually select a storage bubble from different perspectives.

To make it possible to compare the amount of content of different modality, e.g. audio and video, the icon size can be related to the number of streams or files stored on the device rather than the storage size. Using, for instance, a touch screen interface clicking an icon 12, 13, 14, 15 will show a list or summaries of the content represented by the icon.

It is possible to realize just one of the above mentioned indication methods (via display, or color) or a combination of these indication methods in the storage bubble 1.

Summarizing the indication methods it can be said that the color (illumination) indication is the most rudimentary and provides a first clue to the user. When picking up the storage device 1 the user can switch on the display 11, if one is provided, and see what is stored in the bubble 1 in more detail by looking at the icons 12, 13, 14, 15. If, based on the icons shown, the content type of interest is available, the user can browse further by selecting the icon 12, 13, 14, 15 of interest.

In order to save battery life the embodiment of the storage bubble 1, as shown in FIG. 1, has a proximity detection mechanism, indicated with the number 16, or a “pick up” detection mechanism, indicated with the number 17. In this case the different types of optical indications only light up when a user is close to the storage bubble 1 or when the storage bubble 1 is picked up. The proximity detection mechanism 16 can for instance be realized by means of a motion detector connected to the processor 4 which controls the illumination means, e.g. the LEDs 6. The pick up detection mechanism 17 can for instance be realized by means of a contact sensor, wherein the contact sensor can be connected with the processor 4 controlling the illumination means.

The highlighted area 7 in FIG. 2, e.g. being of the color red, in the upper left corner shows that a lot of video is stored on this device. The illuminated area 9 in the right corner, e.g. being of the color yellow indicating the presence of audio, is dimmed with respect to the red area 7, but less than video. The colors—areas 8, 10—indicating the presence of digital pictures are completely dimmed. From the icon 12, 13, 14, 15 appearances and size it is easy to see that the content stored are mostly romantic movies.

Specific content can for instance be represented on the display 11 in the following ways:

Video streams can be summarized by showing a video manga (a video manga is a video summary in the form of a (Japanese) comic book.), a sequence of key frames, a trailer showing some key scenes or a DVD or VHS box cover. Also a simple list with the title and playing actors can be given;

for digital pictures, for instance, thumbnail versions can be shown or an automatically generated photo collage of a set of pictures can be shown;

playing the chorus in case of a popular song, showing the CD cover with song title, showing a transcript of the speech in the audio, could represent audio streams or showing text parts of a text document.

In all cases also a simple directory tree showing file name and other attributes could be given.

FIG. 3 shows an example of a retrieval procedure. The content retrieval starts with selecting the storage bubble 1 based on very rudimentary representation of stored content (color intensity) indicated as step A in FIG. 3. In the example shown in step A the storage bubble 1 containing videos (red color 7 is bright, assuming red presents video) is selected. In step B the display 11 is turned on and it is identified in more detail what type of content is available on the selected storage bubble 1 indicated by means of icons 12, 13, 14, 15 with different sizes. If a user is looking for comedy series, the user can select “comedy series” icon 14.

If the content type of interest is available the content of that type can be browsed using summarized representations (step C). In the present example the user browses through comedy series. The comedy series stored can be represented for instance by the respective video cover 18 or manga.

Because different media, such as audio, video and pictures need different storage capacities and have different content analysis needs, multiple kinds of storage bubbles can be defined. Different storage bubble types can be sold as active counter parts of passive storage media. This will certainly be possible looking at the decreasing trend of processing, storage and networking technology costs. Storage bubble models with the following storage capacities and functionality could be differentiated for instance: A storage bubble 1 with the storage capacity of a typical memory stick or other solid state memory card, e.g. 128 MB, with text and spread sheet analysis capabilities and simple text and spread sheet browsing capabilities or image content analysis capabilities and image thumbnail rendering capabilities;

a storage bubble 1 with the storage capacity of a normal CD with audio or content analysis capabilities and simple audio rendering capabilities;

a storage bubble 1 with the storage capacity of a DVD with video content analysis capabilities and simple video summarization capabilities using thumbnail key frames or a thumbnail video manga compilation;

a storage bubble 1 with the storage capacity of a BluRay Disc with video content analysis capabilities and simple video summarization capabilities using thumbnail key frames or a thumbnail video manga compilation or

a generic storage bubble 1 with a storage capacity of a large HDD, e.g. 300 GB, and a large variety of content analysis capabilities.

What wireless networking capabilities are present could also be differentiated although this will limit the communication only to devices that have the same communication and networking capabilities.

Using for instance a Wireless Fidelity Connection (WI-FI connection) the storage bubble 1 can also directly access an Internet service via a broadband connection, e.g. ADSL. As a service it is, according to an embodiment of the invention, possible to download different content analysis functionalities for a fee from a server via the Internet such that the storage bubble 1 can change its “expertise” from, for instance, audio to digital pictures. The service lists all the content analysis possibilities for each storage bubble model.

Further the Internet service provides, according to a further embodiment of the invention, content that fits in the profile 3 of the storage bubble 1. The content of interest can be bought directly from the Internet service. A user can for instance set in the profile 3 of the storage bubble 1 the maximum amount of money that the storage bubble 1 can spend. The user can give, when subscribing to the online service, all information to make an automatic purchase possible, e.g. credit card information.

To give a user more control over purchase the user can get a message, e.g. an SMS, MMS or e-mail, with a link to a site enabling a user to cancel or approve the order put by a storage bubble 1. The message mentioned above can, according to an embodiment of the invention, be transmitted to the storage bubble 1 and be displayed on the storage bubble 1 too. Although the focus here is on portable storage bubbles 1 the method described above can be applied to network storage devices in general.

FIG. 4 shows a distributed self-organizing system 19 for the storage of data according to the invention. The system comprises a network 20 of N storage bubbles 21, 22, 23, 24 of the type of the storage bubble 1 described above and shown in the FIGS. 1-3 and stationary and non autonomous storage devices 25, 26, 27, such as for instance a Personal Computer, a home media server, a HDD-, DVD-or so called “blue ray” recorder. Content of interest for a storage bubble 21, 22, 23, 24 not available on any of the storage bubbles 21, 22, 23, 24 can be retrieved from the stationary or other storage devices 25, 26, 27 that can store content from external sources like analog audio/video broadcasts 28, digital video broadcasts 29, digital home video/picture/audio content 30, internet content 31 or non broadcasted published content 32 (audio, CD, DVD, etc.). Content can also be available from an external network, e.g. the Internet.

Self organization of the content stored in the system 19 can be achieved very easily since the storage bubbles 21, 22, 23, 24 are arranged to exchange content and other data, e.g. meta data, with one another, using wireless networking technology, for instance WI-FI and Bluetooth, such that the profiles of all the bubbles 21, 22, 23, 24 are satisfied as much as possible.

The protocol and interface for content and (meta) data exchange and processing can for instance be an industry standard protocol and interface, e.g. MPEG-21, uPnP, or any proprietary protocol and interface.

Although digital home video/audio/pictures can be seen as an external source digital video cameras 33 and audio recorders having network capabilities can directly be accessed by a storage bubble 21, 22, 23, 24. In general any device with wireless network capabilities that implements a protocol and interface for content and Meta data exchange and processing can directly be accessed by a storage bubble (FIG. 5).

According to FIG. 5 storage bubbles 21, 22 in general communicate and exchange information by a standardized protocol STP and standardized interface STI. In general storage bubbles 21, 22, 23, 24 do not have means to directly get content from input sources such as analog cable TV/radio or a DVD. To get content not already available on the storage bubble network, indicated with 20 in FIG. 4, they can communicate, using for instance a WI-FI connection, with storage devices 25, 26, 27, 33 which have these means. In order to do this with a large number of devices from different vendors the interfaces 34 and protocols 33 used are preferably standard.

Although a storage bubble 21, 22, 23, 24 could in principle get content directly from input sources this is not the main intention of storage bubbles. Although storage bubbles can have different forms and implementations, they are generic storage devices independent of any form of content type and specific means of retrieving information, such as a tuner for analogue digital video broadcasts or a DVD. Further the costs of a storage bubble 21, 22, 23, 24 as a consumer electronics product should be low such that consumers are willing to buy many storage bubbles 21, 22, 23, 24 enabling the concept of self organization. But nevertheless a storage bubble 21, 22, 23, 24 can comprise, although it is not the preferred embodiment, rendering capabilities.

The more storage bubbles 21, 22, 23, 24 there are available in the system 19 the more fine grained the content can be semantically segmented over multiple storage bubbles, the easier it gets to physically retrieve specific content by selecting a specific bubble, the bigger the total storage capacity of the bubble network, the more content redundancy can be created, the easier it is for users to consume the same content at possibly multiple locations that are not connected through a communication network.

Further the system 19 is arranged to search for data stored on the storage devices 25, 26, 27, 33 that match with user set profiles of the storage bubbles 21, 22, 23, 24 and to store data matching with the storage profile of a storage bubble 21, 22, 23, 24 in this bubble.

For instance one storage bubble 21 has the profile to collect songs of a certain kind for a low bandwidth environment (e.g. environments where only communication via Bluetooth is available) it will communicate with other storage bubbles 22, 23, 24 of the same or other type and ask for popular songs in a low bit rate format. A storage bubble 22 that has some popular songs could for instance, indicate that the popular songs can be moved to the storage bubble 21 instead of copied because the popular songs do not really fit in its own profile, and better fit with the other storage bubble's profile.

The self organization of the storage system 19 results in a physical separation of content on the different storage bubbles 21, 22, 23, 24. A user can physically grab the content he or she is interested in because of the storage bubble's means of showing what content is stored on a storage bubble 21, 22, 23, 24. In this way the storage bubbles 21, 22, 23, 24 organize the available content such that each storage bubble 21, 22, 23, 24 complies with its profile as good as possible. This mechanism enables users to physically get content they are interested in by selecting a storage bubble. Thus the system 19 comprising storage bubbles 21, 22, 23, 24 represents a distributed storage home network. This instead of a centralized or less distributed network.

By physically organizing content in the portable storage bubbles 21, 22, 23, 24 according to the invention it is not hard to envision a consumer's home filled with storage bubbles 21, 22, 23, 24 of this kind in drawers, under the bed, close to some rendering devices etc. If, for instance, a user likes to watch action movies he/she could look in the drawer for a green lit storage bubble, when green corresponds to the genre “action movies”. When the user found such a bubble he/she could, for instance, put it close to a TV equipped with means for communicating with the storage bubble, e.g. Bluetooth, and play one of the action movies stored on the bubble. Alternatively, for example, the user could instruct the storage bubble to stream the content to the TV of choice.

In general there are three sources of content for a storage bubble 21, 22, 23, 24: other storage bubbles 21, 22, 23, 24, stationary storage devices 25, 26, 27, 33 or an external network such as the Internet. For all content stored on storage bubbles 21, 22, 23, 24 Meta data will be available that are needed by another storage bubble 21, 22, 23, 24 to decide whether the content is of interest. On the other hand, for stationary storage devices and other common storage devices 25, 26, 27, 33 the availability of the meta data of interest or even any meta data can not be assumed.

Assuming that a stationary or other storage device 25, 26, 27, 33 provides uPnP like services, such as providing lists of available content and of what type the content is, e.g. pictures, audio, video or any other type of data, a storage bubble 21, 22, 23, 24 can download and analyze the content stored on these devices 25, 26, 27, 33. Based on this analysis a storage bubble 21, 22, 23, 24 can decide by comparing the analyzed content with its profile what content to copy to its own storage space. Content analysis of content from a stationary or other storage device has to be performed only if no other storage bubble 21, 22, 23, 24 has analyzed that content before to obtain the same meta data. To ascertain whether a content in question is already analyzed a storage bubble 21, 22, 23, 24 can send a request to the other storage bubbles 21, 22, 23, 24 in the network 20.

A storage bubble 21, 22, 23, 24 will start analyzing external content only if the request to other storage bubbles 21, 22, 23, 24 for meta data did not succeed. A storage bubble 21, 22, 23, 24 can store meta data of any content analyzed by that storage bubble, even if the content was not copied to the storage bubble, because it did not fit the profile of the device.

Because the amount of content to be analyzed can be large a storage bubble 21, 22, 23, 24 can request other storage bubbles to help to search for content that fits the profile of the storage bubble 21, 22, 23, 24 requesting the help. Storage bubbles 21, 22, 23, 24 that honour that request for help get assigned a part of the content list to analyze. The helping storage bubbles 21, 22, 23, 24 send the content analysis results back to the requesting storage bubbles 21, 22, 23, 24.

According to an embodiment of the invention the storage bubbles 21, 22, 23, 24 can decide to honour a content analysis help request if they have fulfilled their own profile goal. That is when all content available from any storage device 21, 22, 23, 24, 25, 26, 27, including other storage bubbles 21, 22, 23, 24, has been analyzed and no new content was found that matches the assigned profile. Using a standard like uPnP, a storage bubble 21, 22, 23, 24 can subscribe to a storage device 25, 26, 27, 33 to get a signal when new content is available on that storage device 25, 26, 27, 33. When it is signaled, the respective storage bubble 21, 22, 23, 24 could analyze the content and decide if the content is of interest based on the assigned profile.

In principle it is also possible that a storage bubble 21, 22, 23, 24 misses some of content analysis capabilities that are required to fulfill its profile. In that case a storage bubble 21, 22, 23, 24 can according to an embodiment of the invention negotiate with another storage bubble 21, 22, 23, 24 with the right capabilities to do the content analysis.

The generated meta data of any content that is analyzed is kept on the storage bubble 21, 22, 23, 24 that has analyzed the content. If the content analysis was done upon request of another storage bubble 21, 22, 23, 24 the meta data can also be copied to the requesting storage bubble. The meta data are associated to content through identifying information about the content, such as file name and creation date.

By keeping the meta data of any content analyzed on the storage bubbles 21, 22, 23, 24 that analyzed the content or has requested analysis a partially redundant distributed meta data database builds up in the network of storage bubbles. Thus by means of the storage system according to the invention a distributed Meta data database can be achieved.

It must be noted that the content analysis could be replaced by human annotation of the content using a user interface. This is only feasible if the Meta data of interest are restricted to rudimentary information such as genre. Semi-automatic annotation techniques can result in more detailed annotations, e.g. the user can indicate in one image who is the grandmother, the storage bubble can use this information to find and annotate the presence of the grandmother in other images.

According to an embodiment of the invention a user is able to control which of the storage bubbles 21, 22, 23, 24 or other devices 25, 26, 27, 33 have access control to the content stored on the storage bubbles 21, 22, 23, 24. For instance using uPnP, a storage bubble 21, 22, 23, 24 can discover other devices 25, 26, 27, 33 in the network. For each device 21, 22, 23, 24, 25, 26, 27, 33 the user can specify what access rights it has. Also access rules with which a user can provide general security rules, e.g. “all devices can access all music on this bubble”, can be defined in the profiles of the storage bubbles 21, 22, 23, 24.

Since all storage bubbles 21, 22, 23, 24 can communicate and exchange data with one another all the storage bubbles 21, 22, 23, 24 of the network 20 can be virtually represented by any device able to communicate with the storage bubbles 21, 22, 23, 24.

According to FIG. 6 a device 34 representing a remote storage bubble, indicated with 21, 22, 23, 24 in FIGS. 4 and 5, can browse all content stored on this storage bubble 21, 22, 23, 24. In FIG. 6 a remote storage bubble 21, 22, 23, 24 is represented by means of an elliptic icon 35, 36, 37, 38 shown on a display 43 of the device 34. Each of these elliptic icons 35, 36, 37, 38 is divided into areas 39, 40, 41, 42, wherein each area 39, 40, 41, 42 indicates the content stored on the allocated storage bubble 21, 22, 23, 24. For example the area 40 represents videos, the area 41 music, the area 42 pictures and the area 39 text stored on the storage bubble 21. The color and brightness of the areas indicates what is stored on the respective bubble 21, 22, 23, 24. Thus the user can understand what is stored on the storage bubbles 21, 22, 23, 24, e.g. on the storage bubble 21 by different degrees of brightness of the areas 39, 40, 41, 42, analogous to the illumination means described above and shown in FIGS. 1 and 2.

Also for playback of streams or viewing files the stream or file of a remote storage bubble 21, 22, 23, 24 can be routed to the representing device 34. This device 34 can be used as a storage device manager. This “manager” device 34 can for instance temporarily act as a master in the network 20 of storage bubbles shown in FIG. 5. This master collects information from the other storage bubbles 21, 22, 23, 24 in the network 20.

From the perspective of the manager device 34 able to represent any storage bubble 21, 22, 23, 24 in the network 20, all the content in the storage network 20 seems to be hierarchically clustered in an intelligent way. This is because the content is intelligently clustered over multiple levels of information detail (e.g. on the highest level only a color indicator is used on a lower level icons are used, etc.). Especially when users have many storage bubbles 21, 22, 23, 24 it is of interest to have an overview of all storage bubbles 21, 22, 23, 24 in the network 20. In general, from the perspective of the manager device 34, the user can transparently browse the combined storage space created by all storage bubbles 21, 22, 23, 24; thus the user does not have to know on which storage bubble 21, 22, 23, 24 content of interest is stored.

FIG. 7 shows a method for the retrieval of a desired content using the device 34 providing an overview of all the storage bubbles 21, 22, 23, 24 in the storage system 19, as shown in FIG. 4 or 5, by giving rudimentary visual information about what is stored on the storage bubbles 21, 22, 23, 24 (step A). By selecting one of the icons 35, 36, 37, 38 each representing a storage bubble 21, 22, 23, 24, e.g. via point and click or touch, more information about the content stored on the selected storage bubble 21 can be given (step B, C).

The user interface of the selected storage bubble 21 can be routed to and shown on the manager device 34 (step D). In this way using a storage bubble as a storage bubble manager 34 a user can perform search actions such as shown in FIG. 3 remotely. Even more the device manager 34 can route audio and video streamed from the remote storage bubble 21 to the rendering device 44 (step E).

Thus the manager device 34 can act as a virtual representation of a remote storage bubble 21, 22, 23, 24. If a user does not want to physical get a certain storage bubble 21, 22, 23, 24, the user can pick up a storage bubble 21, 22, 23, 24 close to him or her and use this as a virtual representation of the selected storage bubble 21, 22, 23, 24. To provide the manager functionality described above the storage bubbles 21, 22, 23, 24 each can comprise a respective software installed in their processors. In a preferred embodiment a user can choose from a menu shown on the display of the selected bubble, e.g. the bubble 22, the menu point “make this bubble a bubble manager”. After activating this menu point the bubble 22 can send via its communication means, indicated with 2 in FIG. 1, requests to the other bubbles 21, 23, 24 to transmit information about the contents stored in them. Meta-data about content on storage bubbles that do not react could be replaced by information that is available in the local meta-data base of the storage bubble acting as manager; the content of the non-responsive bubbles of course remains unreachable. The storage bubble manager could indicate this. Further, it could be possible that content of the non-responsive bubble is available on any other bubble that is reachable. When a user selects content of a storage bubble that is unreachable the manager could select a copy of the selected content on another bubble that is reachable.

The content stored in the storage bubble network 20, as shown in FIG. 4, can be represented in a hierarchical manner (FIG. 8). In FIG. 8 the synergy between virtual and physical representation of storage bubbles 21, 22, 23, 24 is shown. Per column I, II, III, IV shown in FIG. 8 the content is physically segmented on different storage bubbles 21, 22, 23, 24. Per row A, B, C, D, E the content is virtually segmented at multiple content representation levels. The row A represents the content in a most rudimentary way, wherein the degree of granularity is becoming finer in the direction of the arrow. Thus row E represents the content in a way of most fine granularity.

According to FIG. 8 all the content available in the storage bubble network indicated with 20 in FIGS. 4 and 5 is logically clustered in an intelligent way by means of the bubble manager 34. The intelligent clustering of content is also performed by using the meta data provided by the storage bubbles 21, 22, 23, 24, wherein similar contents build clusters 45 of multiple levels of granularity. So videos stored in the storage bubble network 20 can constitute a cluster. This cluster can be divided into sub-clusters such as action movies or comedies etc. These sub-clusters can be divided in further sub-clusters according to for instance actors who play in the movies etc. All these information used for clustering are available in the form of Meta data.

Also the content analysis processing in the storage system or the network of storage bubbles can be done centralized by a master device too, e.g. on the storage bubble manager 34.

Further instead of having the bubbles just lying around, the bubbles 21, 22, 23, 24 could be inserted in collets or slots, respectively, of a kind of grid-tray 49 connected or connectable to the storage bubble manager 34 as shown in FIG. 9. In this way power can be supplied by the bubble manager 34 and possibly also all communication between the bubbles could be handled. The storage bubbles 21, 22, 23, 24 can comprise according to this embodiment of the invention connection means corresponding with connection means of the grid tray to provide bus bar or data bus connections, e.g. metal sheets. The grid tray 49 can comprise, according to an embodiment of the invention, retainers 44, 45, 46, 47, 48 for the storage bubbles 21, 22, 23, 24 and the management device 34 in which the bubbles 21, 22, 23, 24 and the management device 34 can be put into. The power for the storage bubbles 21, 22, 23, 24 can be supplied by means of the grid tray 49 itself too, e.g. the grid tray can comprise a power supply. Alternatively the grid tray 49 can be connected to the public electricity network, e.g. by means of a suitable current adapter.

In the embodiment using the grid tray 49 the storage bubbles 21, 22, 23, 24 can be very simple. The simplest forms are storage bubbles 21, 22, 23, 24 only containing storage, a small display and/or other indication methods and a processor.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of hardware. The mere fact that certain measures are recited in mutually different dependent claims does not indicate that a combination of these measures cannot be used to advantage.

A further aspect of the invention relates to a method of organizing content in a network of data storage devices. In this particular embodiment the content is a so-called Autonomous Content Entity (see European IST 6^{th} Framework project AceMedia), in short ACE. Such an ACE is stored on an ACE enabled device and comprises representation-data representing the content itself, like music, photos, video, documents or the like. The ACE further comprises organizing-data for organizing the content in the network. The organizing-data comprise a layer of executable program code, e.g. at least one command but typically sets of commands, for being executed by command processing means of the device. The relationship of such ACEs to the above-mentioned bubbles is given in the fact that ACEs are software versions of the storage bubbles. In contrast to the storage bubbles ACEs can organize themselves over different physical or logical locations. The storage bubbles mentioned above as they are implemented by hardware cannot achieve this.

Such command processing means of said device are e.g. arranged for providing functionalities like ACE to ACE communication, allowing an ACE to request properties and capabilities of the local device or perhaps of any device on the local network, allowing ACEs to contact sites on the web for updates, for fresh metadata, or information from the web in general, allowing ACEs to get content from a repository, allowing an ACE to create its own GUI pane, onto which content can be rendered and UI elements like buttons and sliders can be placed. These functionalities are provided by a so-called application modules on an ACE enabled device. In this exemplary embodiment the functionality of allowing ACEs to get content (i.e. ACEs, or representation-data of ACEs or content of ACEs) from a repository is of particular importance as will be described below.

The ACE enabled device further comprises a so-called ACE Manager or Kernel. The ACE Manager acts as a central coordinator that mediates between the ACEs, the user and the outside world of the device. The ACE manager is an active component that uses the functionalities of other components, such as ACE storage and ACE execution.

An ACE can be inactive (i.e. its code is just residing in the repository) or active. In order to activate an ACE, the ACE Manager gets the ACE commands and gives it to the command executing means, where the appropriate ACE method is run. The ACE commands may implement self-replication behavior and self-presenting functionality (e.g. a photo album that can make a collage of itself and show it to the user). ACEs can also communicate messages via an interface, via which the ACE Manager can deliver or receive these messages.

The organizing-data further comprise an organizing-profile for representing a desired organization of the content in the network. The organizing-profile can be set or adjusted by a user of the device any time the user has the desire to do so.

According to the invention the method of organizing content in the network comprises the step of using a content, which is an ACE, on a first device for creating an organization-request by the aid of the organizing-data. Herein the word using means that the executable commands of the ACE are executed by the command processing means and during the execution said organizing-profile is utilized to create the organizing-request. Hence the “intelligence” of the ACE itself is active in this process and only supported by the device. Accordingly the organizing request represents the organizing-profile for which matching ACEs or representation-data of ACEs are searched in the network.

In a further step of the method according to the invention the organizing-request is communicated by the aid of the above-mentioned features and functionalities respectively to at least a second ACE enabled second device in the network.

In a further step of the method according to the invention the distribution of content between the first device and the second device or a plurality of second devices is re-arranged dependent on the response of the involved devices. In particular this re-arranging depends on the type of self-organization that is selected or provided by the ACEs involved in this process. Basically it must be distinguished between a first type of self-organization, which is the organization of ACEs, and a second type of self-organizing, which is the organization of content over ACEs.

With respect to the first type of self-organization two different modes can be distinguished. These modes are the delegation-mode and the pro-active mode. In the delegation-mode an ACE (e.g. ACE A) asks other ACEs (e.g. ACE B1, B2, . . . Bn) to act on the profile of the ACE A if appropriate. In the pro-active-mode the ACE A requests so called meta-data, which represent the representation-data stored in the other ACE, of the other ACEs from these ACEs and acts on this information if this is appropriate based on its own organizing-profile.

The functionalities or activities relating to self-organization are explained by reference to the FIGS. 10 to 13, in which the following abbreviations have been used:

AceBrowser means a software program by the aid of which the user can brows the ACEs that are present in a local device or on a network, and in which a user can execute ACEs that contain executable code in the organizing-data of the ACE.

:INetwork means the network interface, an interface via which the ACE Manager of a device can send messages and data to, and recive messages and data from, other devices in the local network.

:AceManager indicates an ACE Manager as described above.

:IRepository means an interface via which the ACE Manager can retrieve ACEs or representation-data of ACEs from the Repository, which may be located on the local drive, or on any other device on the local network that has a Repository.

:Ace2System:AM means an interface via which an ACE executing on the local device is able to retrieve system information, for example the amount of available storage space on a device, the type of a device (e.g. being mobile or having fixed location), or the amount of energy available in the battery of a device. The abbreviation AM refers to the name “Application Module”, used for any software component that provides an interface via which ACEs are able to use functionalities in the software component.

A2:Intelligent Layer means the executable code in the organizing-data of an ACE, named A2;

:ExEnv refers to the said command processing means, which is named “Execution Environment” (ExEnv) in the figure.

Ace2Ace:AM means the ACE to ACE communication component, an interface via which an ACE can communicate with another ACE, which may be located on the same device as the first ACE or on another device in the local network.

In the following a scenario is described, in which representation-data is copied, which leads to a collection of content. Reference is made to FIG. 10.

‘Antonio is web-browsing on the couch, using his WebTablet. He suddenly gets the nice idea to make a photo collage, to get himself in the holiday mood. He surfs to aces4free.com and searches for ‘holiday’. One of the hits is an ACE item called “Aloha—beach & surf” which contains a collage of 10 nice photos of Hawaii.’

At this point it needs to mentioned that some sites offer free ACEs, created by users themselves. The site provides security checks on ACEs. The users trust these ACEs.

‘The description reads “This ace will find all beach & surf stuff in your collection—enjoy dudes”. Antonio clicks the link and thereby downloads the ACE. He switches to his ACEBrowser applications to start the ACE.’

It is mentioned that an ACEBrowser is a separate application that communicates with the aceMedia platform on the WebTablet. It allows a user to browse and run ACEs.

‘First, the ACE displays itself as a collage on the WebTablet. An icon indicates that the ACE is meanwhile looking for other beach and surf photos.’

It is to mention that the Aloha ACE performs a query (home-network-wide) for similar photos to the ones it already contains, and for photos having keywords “beach” and “sea”. Matching photos are being collected in the ACE. The query is sent from the local device (WebTablet) to all ACE-enabled devices in the home.

‘The ACE also looks for any song of“The Beach Boys”, but Antonio has none. After 40 photos, the ACE stops collecting and displays (the first part of) a collage of all collected beach photos on the WebTablet screen. Antonio is happy that his photos are so beautifully collaged; he removes a few that are boring and clicks the “save collage” button.’

It is to mention that, in this instance, the executable code in the ACE has the “intelligence” or knowledge to create nice collages. The ACE behaves well: without explicit user consent, no user-owned pictures are saved.

‘Browsing the repository, Antonio sees the new Aloha ACE there and decides to mail it to his sister Laura.

Later that day, Laura receives the email from Antonio on her PC. She clicks the attached ACE. The ACE shows itself as a collage in a window, and the text below the! collage suggests that Laura should click the button “Add my beach photos” in order to add her own beach photos.’

It is to mention that the ACE is able to keep its state: it knows that it has already collected pictures once before. It also detects a new environment (at Laura's) so it presents the option to add more beach photos.

‘She clicks the button and 10 photos from Laura's PC are found and added to the collage. Laura mails the ACE back to Antonio straight away! Meanwhile she enjoys the collage and starts thinking about holidays . . . ’

In the following a scenario is described in which self-organization is explained by the aid of a leader-follower-concept, in which one ACE takes the role of a leader and others take the role of followers. The scenario described is schematically shown in FIG. 11 and FIG. 12 and FIG. 13.

‘Recently Laura upgraded her home network to be ACE-compliant. Her ACEs containing photos, music and videos are automatically organized across several ACE-enabled devices. Laura's home network consists of several small portable storage devices, digital photo album, a laptop, PDA and a general storage server.’

It is provided that all of Laura's content consists of ACEs. By default, code for self-organization behaviour is added in the ACE Intelligence layer for all new content that is created. All devices that create or import content are configured to insert such default code modules into an ACE. This code may be combined with other code for other functions that are needed in an ACE.

‘Today Laura wants to change the default organization a bit. Using her AceBrowser she can browse all ACEs in the network. She selects two music albums (ACEs) on her mp3 player, that she likes a lot. The GUI of the ACEs appears on her screen, %with the button ‘Collect similar items on mp3-player’. Laura clicks the button, and selected music albums start to copy themselves to the mp3-player.’

At this point it needs to be explained that the button triggers self-organization. The selected ACE becomes a ‘leader’ that gathers similar items around it, the ‘followers’. The leader stays at its current device. The Intelligence code for leader/follower is the same—the user, using the AceBrowser, initiates the change of roles. Content is selected based on: number of times played, type of content (mp3 songs/albums only), storage space of the mp3 player, genre of the music. Copy is used by default, not move, because the mp3-player is a mobile device. The ACEs know this.

‘Next, Laura selects one of the old TV recordings on her ACE-PVR, moves it to the storage server, then uses the option ‘Collect similar video around me’. This starts a process of old TV recordings moving from the PVR (and several other devices in the home!) to the storage archive server. The PVR is now almost empty, so it is ready to record new TV programs again.’

Similarity is now based on: date of the TV recordings, number of times played, type of content (video only), storage space of the server (it has plenty of room in this example), and perhaps genre of the video.

According to the above-described scenario ACE mobility (shown in the sequence diagram of FIG. 11) is required for self-organization of the first type. The sequence diagram shows how an ACE A2, which is currently running on a device Y, requests to be moved to a device X. The ACE Manager has to approve the move; the request could be denied e.g. if moving ACEs violates a security policy. The ACE Manager also takes care of coordinating the move—it uses the repository and the network interface to accomplish this task.

Also ACE to ACE communication or inter ACE communication is required in order to enable self-organization of ACEs. The sequence diagram of FIG. 12 schematically shows how a message from ACE A2 to an ACE A1 is sent, wherein the ACE A1 is located on another device as the ACE A2. The application module ACE to ACE communication (“Ace2Ace:AM” in the figures) is used by A2 as an interface that allows ACE to ACE communication. The ACE Manager is a central coordinating component and has the power to refuse ACE to ACE communication, e.g. if this violates a local security policy.

Also ACE massage broadcasting is required for the purpose of self-organization. The sequence diagram of FIG. 13 schematically shows how a broadcast is delivered within one ACE enabled device. It is assumed that no ACEs are active (running) at the time the message is received, so they have to be instantiated. The broadcast message “msg” is received by the ACEManager—it may have arrived from a local ACE, or from a remote ACE via the network interface (:INetwork).

The message is delivered to N ACEs on the device, which were not active (running, with thread) at the moment of arrival of the message. Therefore, the inactive AC:Es have to be fetched through the repository interface, and instantiated, before the message car be delivered. The execution environment (ExEnv) judges whether each ACE has an appropriate method to receive message msg (in other words, if the ACE is an intended recipient of broadcast msg). ACEs that do not have a suitable method are not instantiated. Ace2Ace: AM remains inactive. It is only called if an ACE needs to send a broadcast. The ACEManager performs ACE message delivery.

By providing the above-mentioned features and functionalities it is advantageously achieved that ACEs, which are intelligent active content, can actively search and gather representation-data stored in other ACEs that are located within one device and/or distributed over several devices over the network. Hence the distribution of representation-data in the network is changed by the aid of communication between the ACEs, which reflects a self-organization of representation-data based on ACE activities. By providing the above mentioned features and functionalities it also advantageously achieved that ACEs that are distributed in a device and/or over several devices in the network can actively move themselves in the network or generate children (copies or duplicates having identical or similar properties) of themselves within the network and/or within devices by the aid of inter-ACE-communication. Hence the distribution of ACEs in the network is changed by the aid of communication between the ACEs, which reflects a self-organization of ACEs itself based on ACE activities.

1. A portable data storage device (1) comprising means (2, 4) for searching for data stored on another device (21, 22, 23, 24, 25, 26, 27, 33) that matches a user configurable profile (3) of the data storage device (1) and for receiving data from another device (21, 22, 23, 24, 25, 26, 27, 33) and means (5) for storing said received data in the data storage device (1) if said received data matches said profile (3).

2. A data storage device (1) as claimed in claim 1 comprising means for performing, response to a search request of said other device (21, 22, 23, 24, 25, 26, 27, 33), a transmittal of found data to said portable data storage device (1) matching user set profile of the other device (21, 22, 23, 24, 25, 26, 27, 33).

3. A data storage device (1) as claimed in claim 2 comprising means for deciding, using its own user set profile (3) and a user set profile of the other device (21, 22, 23, 24, 25, 26, 27, 33), whether to transmit only a copy of data requested from the at least one other device (21, 22, 23, 24, 25, 26, 27, 33) or to move the requested data to the other device (21, 22, 23, 24, 25, 26, 27, 33).

4. A data storage device (1) as claimed in claim 1 comprising means for analyzing the content of data.

5. A data storage device (1) as claimed in claim 4 comprising means for indicating analyzed data by Meta data.

6. A data storage device (1) as claimed in claim 1 comprising means for wireless communication and data exchange with the at least one other device (21, 22, 23, 24, 25, 26, 27, 33).

7. A data storage device (1) as claimed in claim 1 comprising means (6, 11) for visually representing the content of the data stored optically.

8. A data storage device as claimed in claim 7, wherein the means (6, 11) for visually representing the content stored comprise means for lighting the exterior of the device (1) using multiple colors and/or light intensities depending on the content stored.

9. A data storage device (1) as claimed in claim 7 comprising means for browsing said stored content.

10. A data storage device (1) as claimed in claim 7 comprising means (16, 17) for detecting proximity of a user and/or detecting movement of the storage device (1) wherein the means (6, 11) for visually representing the stored content are only activated, when a user is detected in the proximity of the storage device (1) or movement of the storage device (1) is detected.

11. A data storage device (1) as claimed in claim 1, wherein the profile (3) contains information selected from the group consisting of information about the content to be stored, date of creation, change of data, behavior of the storage device indicating how to deal with external requests of other devices, behavior of the storage device indicating how to deal with storage shortage, and the type of data to be stored.

12. A distributed self organizing system (19) for the storage of data, which system (19) comprises at least two autonomous storage devices (21, 22, 23, 24) comprising means for exchanging data with one another, wherein the system (19) is arranged to search for data stored on the storage devices (21, 22, 23, 24), that match A+k;3a user set storage profile of at least one of the data storage devices (21, 22, 23, 24) and to store data matching said storage profile of a data storage device (21, 22, 23, 24) in that device.

13. A system as claimed in claim 12 comprising means for analyzing the content of data stored on the storage devices (21, 22, 23, 24) and characterizing the analyzed content by means of Meta data.

14. A system as claimed in claim 13, wherein storage devices (1, 21, 22, 23, 24) comprise means for analyzing contents of data stored in the system (19).

15. A system as claimed in claim 13 comprising a master device (34) for analyzing contents of data stored in the system (19).

16. A distributed self organizing system (19) for the storage of data, which system (19) comprises at least two autonomous storage devices (21, 22, 23, 24) comprising means for exchanging data with one another, wherein the system (19) is arranged to search for data stored on the storage devices (21, 22, 23, 24), that match with a user set storage profile of at least one of the data storage devices (21, 22, 23, 24) and to store data matching with said storage profile of a data storage device (21, 22, 23, 24) in that device, which system comprises at least two storage devices (21, 22, 23, 24) according to claim 1.

17. A system as claimed in claim 13, which system (19) is arranged to distribute content analysis jobs over multiple storage devices (1, 21, 22, 23, 24).

18. A system as claimed in claim 12, which system (19) is arranged for representing content stored divided by hierarchical clusters representing the content at multiple levels of detail.

19. A system as claimed in claim 15, which system (19) comprises a grid tray (49) connected to the master device (34), wherein storage devices (21, 22, 23, 24) can be inserted into or connected to the grid tray (49) and the grid tray (49) serves as a bus bar for these storage devices (121, 22, 23, 24), wherein a power supply for the storage devices (1, 21, 22, 23, 24), which are inserted into the grid tray, is provided by a power supply connected to the grid tray and/or the grid tray (49) provides a communication bus for communication between the master device (34) and the storage devices (21, 22, 23, 24).

20. A system as claimed in claim 12, wherein the profile of the at least one storage device (21, 22, 23, 24) contains information selected from the group consisting of information about the content to be stored, date of creation, change of data, behavior of the storage device indicating how to deal with external requests of other devices, behavior of the storage device (21, 22, 23, 24) indicating how to deal with storage shortage, and type of data to be stored.

21. A system as claimed in claim 12, wherein said system is used as a distributed meta data database.

22. A method of a self organizing storage of data, comprising searching for data stored on a first data storage device (21, 22, 23, 24, 25, 26, 27, 33) that matches with a user set storage profile (3) of a second data storage device (21, 22, 23, 24), wherein data stored on the first data storage device (21, 22, 23, 24, 25, 26, 27, 33) matching the profile of the second data storage device (1, 21, 22, 23, 24) will be stored Salon the second data storage device (21, 22, 23, 24).

23. A method as claimed in claim 22, wherein data matching a user set storage profile of the first data storage device (21, 22, 23, 24), that are stored on the second storage device (21, 22, 23, 24) will be stored in the first data storage device (21, 22, 23, 24).

24. A method as claimed in 22, wherein a content analysis of the data stored in other storage devices (21, 22, 23, 24) is done by each storage device (21, 22, 23, 24).

25. A method as claimed in claim 22, wherein a content analysis of the data stored in other storage devices (21, 22, 23, 24) is centralized by a master device (34).

26. A method as claimed in claim 22, wherein the content of data stored on the storage devices (21, 22, 23, 24) is characterized by meta data.

27. A method as claimed in claim 22, wherein content analysis jobs are distributed over multiple storage devices (21, 22, 23, 24).

28. A method as claimed in claim 22, wherein the profile (3) contains information selected from the group consisting of information about the content to be stored, the storage device indicating how to deal with external requests of other devices, behavior of the storage device indicating how to deal with storage shortage, and data formats.

29. A method of doing business with a storage device (1) as claimed in claim 1, wherein found data that will be stored is subject to a payment of a fee.

30. A method of doing business as claimed in claim 29, wherein software for analyzing specific contents is downloaded.

31. A method as claimed in claim 29, wherein the storage device (1, 21, 22, 23, 24) autonomously downloads content that matches the storage profile (3) of the storage device (1, 21, 22, 23, 24).

32. A method of organizing of content in a network of devices, content being stored on a device and comprising representation-data for representing the content and organizing-data for organizing the content in the network,
the method comprising the steps of:
on a first device, on which the first content is stored, using said first content for creating an organizing-request by aid of the organizing-data of said first content; and
communicating the organizing-request from said content to another content stored in the first device or stored in at least a second device in the network; and
re-arranging the distribution of content dependent on the response to the organizing-request.

33. A method as claimed in claim 32, wherein
the organizing-data represents at least one executable command for being executed by command processing means of a device and an organizing-profile represents a desired organization of the content in the network; and
said step of creating an organizing-request comprises execution of said at least one command, during which, said organizing-profile is utilized in order to create the organizing-request.

34. A method as claimed in claim 32, wherein
said step of re-arranging comprises moving or copying within the first device or between the first device and at least one second device at least the representation-data or a part of the representation-data of a content from one content to another content if this is appropriate based on the respective organizing-profile-data of a content that is involved in handling the organizing-request.

35. A method as claimed in claim 32, wherein
said step of re-arranging comprises moving or copying at least one content from a first device to a second device.

36. A computer program product directly loadable into the memory of a programmable device, comprising software code portions for performing the steps of a method according to claim 22 when said product is run on the device.
